(19) United States
(12) Patent Application Publication
(10) Pub. No.: US 2011/0084016 A1
(43) Pub. Date: Apr. 14, 2011

(54) FILTRATION ASSEMBLY INCLUDING A CENTRAL TUBE INTERACTING WITH A FILTRATION CARTRIDGE AND WITH A SEAL PERMANENTLY MOUNTED ON SAID CENTRAL TUBE

(75) Inventors: Benoit Le Roux, Fouesnant (FR); Gerard Malgorn, Quimper (FR)

(73) Assignee: CUMMINS FILTRATION, Quimper (FR)

(21) Appl. No.: 12/933,812

(22) PCT Filed: Mar. 20, 2009
(86) PCT No.: PCT/EP09/53317

§ 371 Date: Dec. 15, 2010

(30) Foreign Application Priority Data
Mar. 21, 2008 (FR) 08/01565

(51) Int. Cl. B01D 35/027

(52) U.S. Cl. 210/441

(57) ABSTRACT

A filtration assembly is provided for a fluid flowing in an engine or an apparatus that includes a tank on which a central tube is mounted for interaction with a filtration cartridge including an upper flange and a lower flange between which extends a filtration medium. The central tube is permanently mounted on a bearing member connected to the tank. The central tube bears a first seal and a second seal. The cartridge has a collar forming an extension of the lower flange, the collar being adapted for interaction with the first seal on the central tube in order to ensure tightness between the tube and the cartridge. The second seal is adapted for interaction with the bearing member and/or the collar in order to ensure tightness between the tank and the tube.

### CROSS-REFERENCE TO RELATED APPLICATIONS

This Application is a Section 371 National Stage Application of International Application No. PCT/EP2009/053317, filed Mar. 20, 2009 and published as WO 2009/115605 on Sep. 24, 2009, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FILED OF THE DISCLOSURE

The disclosure relates to the field of the designing and the carrying out of filtration assemblies used to filter the fluids flowing in engines or hydraulic apparatuses.

### BACKGROUND OF THE DISCLOSURE

Filtration assemblies are constituted of a filter body in which there is arranged a filtration cartridge, which generally has a cylindrical shape and which includes a filtration medium, which can for example be made of paper, carton or felt. This filtration medium is conventionally delimited by two end flanges.

Conventionally, filtration cartridges interact with the central tube, whether or not integral with the flanges (the case where the cartridge is integral with a tube intended to interact with another tube permanently mounted in the filtration assembly able to be considered), of which the outside diameter is close to the inside diameter of the filtration medium in such a way as to limit the deformations of the medium under the effect of the pressure being exerted inside the filtration assembly.

According to a first technique, the lower flanges of the cartouches extend in order to have a means for installing and maintaining the cartridge in the filtration assembly, the central tube being in this case mounted and dismounted integrally with the cartridge.

According to another common technique, the filtration assemblies implement a support tube whereon is added the filtration cartridge, the tube being permanently mounted in the filtration assembly.

An embodiment of the invention applies to filtration assemblies wherein the tubes are mounted permanently.

Conventionally, in order to provide the seal between the central tube and the filtration cartridge in the filtration assemblies wherein the tubes are mounted permanently, one or several seals are mounted in cavities arranged in the extension of one of the flanges of the cartridge.

When the cartridge placed in the tank is used, i.e. when the filtering element no longer fulfils its role of filtration satisfactorily, the used cartridge is removed from the tank and it is replaced with a new cartridge.

As has just been indicated, the seal is carried by the cartridge and is consequently replaced integrally with the filtration cartridge at each renewal of the latter.

However, the used cartridges are intended to be incinerated, and the current trend is to reduce in particular the proportion of materials required in the manufacture of such cartridges in order to facilitate their destruction later.

The mounting of a seal on the filtration cartridge does not therefore contribute to the current trend aimed at reducing the production of organic waste.

Moreover, during the replacing of the filtration cartridge, it is necessary to drain the filtration assembly. According to a conventional solution to do this, a valve is provided for this purpose at the lower portion of the tank of the filtration assembly, this valve having to be actuated manually in order to proceed with the draining.

Implementing such a valve therefore involves the manufacture of particular parts as well as the mounting of the latter, which tends to increase the cost of fabrication of the corresponding filtration assembly.

Another solution consists in using a lobe seal when it is removed with the cartridge makes it possible to release an orifice through which the drainage of the tank is carried out, but this solution tends to increase the quantity of waste.

In addition, it is desirable to propose a solution making it possible to proceed with the draining of the filtration assembly without specific intervention of the operator performing the renewal of the cartridge.

### SUMMARY

An embodiment of the invention relates to a filtration assembly for fluid flowing in an engine or apparatus, of the type comprising a tank whereon is mounted a central tube intended to interact with a filtration cartridge comprising an upper flange and a lower flange between which extends a filtration medium, said central tube being permanently mounted on a bearing member integral with said tank, wherein said central tube carries first sealing means and second sealing means, said cartridge having a collar forming an extension on said lower flange, said collar being intended to interact with said first sealing means carried by said central tube in such a way as to provide the seal between said tube and said cartridge, said second sealing means being intended to interact with said bearing member and/or said collar in such a way as to provide a seal between said tank and said tube.

In this way, the seal is provided between the central tube and its bearing member on the one hand and, on the other hand, between the central tube and the cartridge, this with a set of means for sealing (first and second means) permanently mounted in the filtration assembly.

As such, only the cartridge is intended to be replaced, and therefore destroyed, limiting as such the production of waste.

According to an advantageous solution, the filtration assembly incorporates a passage for drainage of said fluid intended to allow for a flow of said fluid from said tank, and the means of closing off of said passage for drainage, prohibiting said flow in the position of interaction of said collar with said first and/or second sealing means, and intended to authorise said flow in the position of removal of said cartridge from said set.

According to this characteristic, means of draining the tank are obtained during the renewal of the cartridge which do not require any specific operation of the operator. Indeed, the simple removal of the cartridge suppresses the interaction of the collar with the means of sealing, which releases the passage for drainage and therefore authorises the draining of the tank.

According to a first embodiment of the invention, said first sealing means are constituted of a central portion of a seal intended to be compressed between said tube and said bearing member, said second sealing means being comprised of at least one external radial extension of said seal extending from said central portion and intended to be compressed by said collar in the direction of said central portion.

Means of sealing as such constituted making it possible to implement a single seal in contact with: the central tube, the bearing member of the tube and the collar of the filtration cartridge. Once the filtration assembly is mounted, the seal between the tube and its support on the one hand and, on the other hand, between the tube and the cartridge, is therefore provided effectively.

In this case, said radial extension or radial extensions are constituted of a lip extending from said central portion in a manner inclined downwards.

According to an embodiment, said passage for drainage is arranged in said tank externally to said bearing member, said means of closing off comprising a flap which can be actuated by said lower flange, said flap being advantageously integral with a plunger intended to interact with said lower flange in order to bring said flap in a position prohibiting said flow, said plunger being coupled to means of elastic recalling tending to bring said flap in a position authorising said flow.

As such, relating to the means involved in the draining of the tank, a solution simple in design involving a relatively easy mounting is obtained.

According to a second embodiment, said first sealing means are constituted of two seals mounted on said central tube in such a way as to separate one from the other while both being intended to interact with said collars.

Note, in this case, that the central tube can for example be press fitted in the bearing member integral with the tank, the second sealing means then being able to be comprised of a seal placed appropriately in the press-fit connection between the tube and the bearing member.

According to other characteristics of this embodiment:

said passage for drainage comprises at least one orifice arranged in said central tube between said two seals;

said seals include a central portion housed in an annular groove of said central tube, and a radial extension intended to be compressed by said collar.

According to a third embodiment, said first and second means of sealing are constituted by a seal comprising a central portion and at least two peripheral radial extensions separated from one another and intended to be compressed by said collar, said central portion being compressed between said central tube and said support elements. In this case, said central portion of said seal has, between said radial extensions, at least one communication orifice with said passage for drainage.

As such, similarly to the embodiment described previously, when the filtration cartridge is removed from the filtration assembly, the communication orifice with the passage for drainage is released, authorising the flow of fluid in order to drain the tank. According to an advantageous solution of this embodiment, said central tube comprises an upper portion intended to interact with said medium and a lower portion comprising a disc carrying said seal and in the thickness of which are arranged said orifice or said orifices.

According to an advantageous characteristic of this embodiment, said upper portion and/or said disc have an annular stop intended to interact radially with said seal; According to a fourth embodiment, said tube has, below said first sealing means, at least one orifice communicating with said passage for drainage, said means of closing off comprising on the one hand at least one radial extension of said central tube extending below said orifice, and, on the other hand, at least one extension of said collar, said extensions being intended to interact with said radial extension in order to prohibit said flow.

Note that, in this case, the central tube can be press fitted in the bearing member integral with the tank, the second sealing means then able to be constituted of a seal positioned appropriately in the fit between the central tube and the bearing member.

In this case, said radial extension of said central tube advantageously has a tapered terminal portion, said extension extending in an expanded manner in relation to said collar in such a way as to have an end portion and intended to act as a bearing between said tapered terminal portion, said end portion being preferentially flexible.

### BRIEF DESCRIPTION OF THE DRAWINGS

Other characteristics and advantages shall appear more clearly when reading the following description of several embodiments of the invention, provided by way of illustrative examples in a non-restrictive manner, and of the annexed drawings wherein:

FIGS. 1 and 2 are diagrammatical views of a first embodiment of a filtration assembly according to an embodiment of the invention, respectively in the assembled state and in situation of removal of the filtration cartridge;

FIGS. 3 to 5 are diagrammatical views of a second embodiment of the invention;

FIG. 6 is a diagrammatical view of a third embodiment according to the invention;

FIGS. 7 and 8 are diagrammatical views of a fourth embodiment of a filtration assembly according to the invention;

FIG. 9 is a detailed view of the mounting of the seal on the central tube according to the fourth embodiment of the invention;

FIG. 10 is a diagrammatical view of an alternative mounting of the seal on the central tube according to the fourth embodiment; and

FIGS. 11 and 12 are diagrammatical views of a fifth embodiment of the invention.

### DETAILED DESCRIPTION OF ILLUSTRATIVE EMBODIMENTS

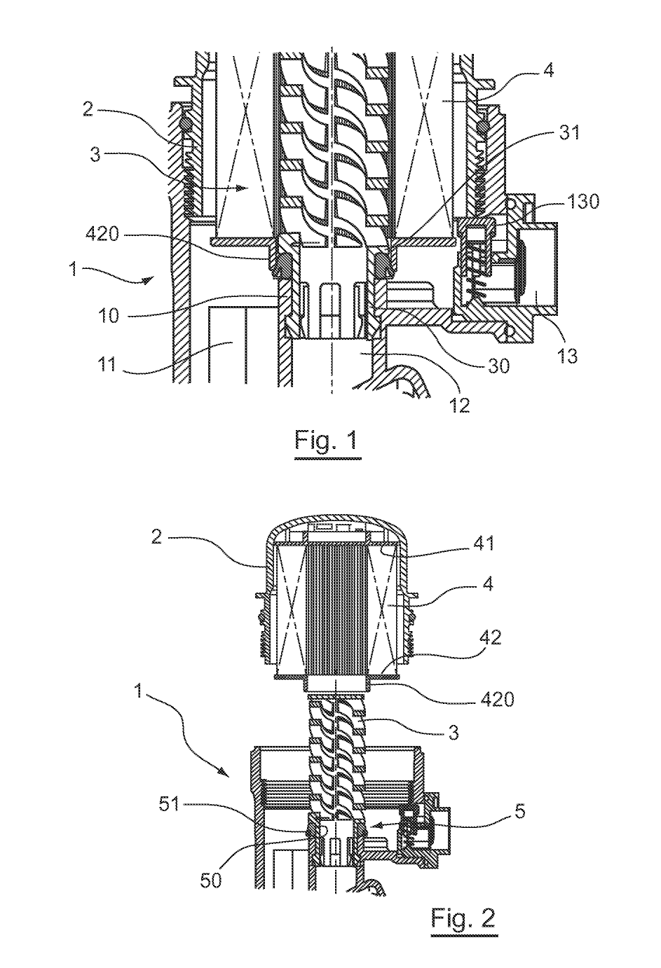

In reference to FIGS. 1 and 2, a filtration assembly for fluid flowing in an engine or a hydraulic apparatus comprises a tank 1 and a lid 2 delimiting a volume wherein is mounted a central tube 3 which supports a filtration cartridge comprising a filtration medium 4 delimited by an upper flange 41 and a lower flange 42.

The tank 1 comprises:

a fluid intake duct 11;

a filtered fluid outlet duct 12;

a return duct 13 to the reservoir of fluid.

Recall that, in a filtration assembly according to an embodiment of the invention, the central tube 3 is permanently mounted on a bearing member 10 integral with the tank, the bearing member 10 delimiting the filtered fluid outlet duct 12 (in practice, the tank 1 is a moulded part incorporating the bearing member 10).

According to this embodiment, a seal 5 is mounted permanently on the central tube 3.

In reference to FIG. 2, a seal 5 comprises according to this embodiment:

a central portion 50, of cylindrical shape, of which the inside diameter is substantially equal (in practice slightly less than) the outside diameter of the lower portion 30 of the central tube, this central portion 50 being intended to be compressed between a shoulder 31 of the central tube (the lower portion 30 engaged in the bearing member 10 extending from the shoulder 31) and the upper end of the upper element 10;

a radial extension 51, in the form of a lip extending from the central portion 50 in a manner inclined downwards.

In parallel, the filtration cartridge has a lower flange 42 which is extended by a collar 420, the latter being intended to interact with the lip 51 in such a way that when the cartridge is mounted on the central tube, the collar of the cartridge tends to compress the lip in the direction of the central portion 50.

As such, the seal 5 exerts a double function, the latter by forming:

first sealing means constituted of the lip 51 which provides the seal between the central tube and the cartridge (by the intermediary of the collar 420 of the latter);

second sealing means, constituted of the central portion 50, providing the seal between the central tube and its bearing member 10.

Note that the central tube 3 is mounted on its bearing member 10 by a non-detachable snap-fit connection.

According to another embodiment of the invention, the filtration assembly comprises means of closing off of the passage for drainage 13, provided for:

prohibiting the flow of fluid in the passage for drainage 13 when the filtration cartridge is mounted in the filtration sensor, i.e., here, when the collar 420 is in the position of interaction with the seal 5;

authorising the flow of fluid in the passage for drainage 13, when the cartridge is removed from the filtration assembly.

According to this embodiment, the passage for drainage is arranged in the tank externally to the bearing member 10.

Furthermore, the means of closing off of the passage for drainage include a flap 130 mounted in a channel communicating with the passage for drainage 13, this flap which can be actuated by the lid 2.

The operation of such a flap is as follows:

when the cartridge is mounted in the filtration assembly, the lid (or the lower flange of the cartridge) presses on the flap in such a way as to bring the flap into the closing off position of the passage for drainage;

when the cartridge is removed from the filtration assembly, the action of the lid (or of the lower flange) on the flap is suppressed and, under the action of a spring, the flap is brought into a position of releasing the passage, authorising the flow of fluid through the passage for drainage.

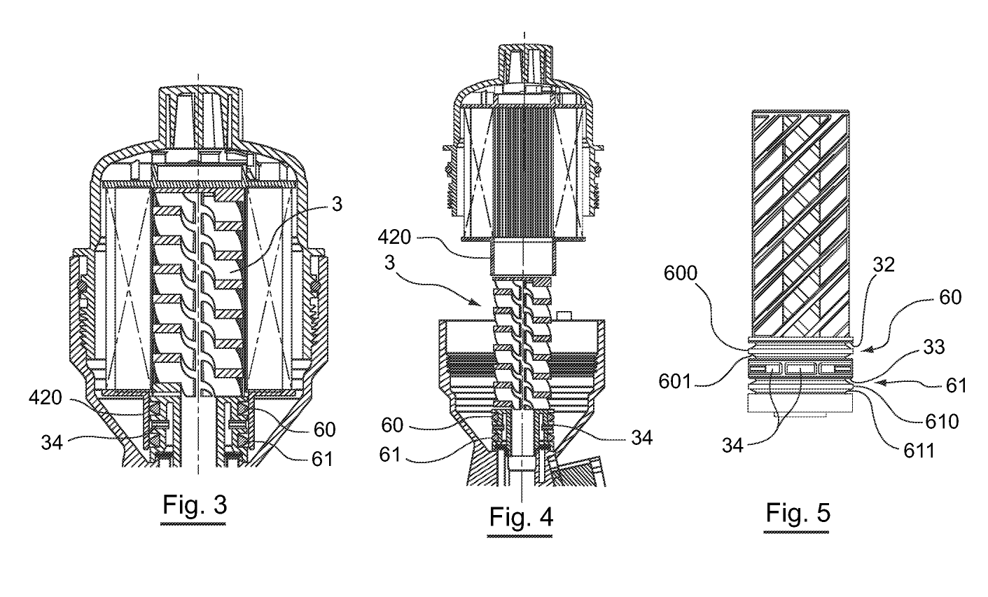

FIGS. 3 to 5 show a second embodiment of a filtration assembly according to an embodiment of the invention.

According to this embodiment, two seals 60, 61 are permanently mounted on the central tube 3, and each contribute, via interaction with the collar 420 of the filtration cartridge, in providing the seal between the tube and the filtration cartridge.

The seal 60 therefore constitutes the first sealing means in terms of this embodiment of the invention.

The central tube is according to this embodiment press fitted, snap fitted or screwed into the bearing member integral with the tank, then seal 61 constituting the second sealing means in terms of this embodiment of the invention.

Such as is shown in FIGS. 3 to 5, the seals 60, 61 are each mounted in an annular groove, respectively 32, 33, arranged in the central tube in such a way that the seals 60, 61 are separated from one another. The seals 60, 61 each have a central portion housed in the corresponding annular groove of the central tube, and a radial extension 600, 610 intended to be compressed by the collar of the filtration cartridge when the latter is mounted in the filtration assembly.

Furthermore, the central tube 3 has, between the annular grooves 32, 33 (and, consequently, between the seals 60, 61), orifices 34 intended to allow for a flow of fluid in the passage for drainage.

According to this mounting, when the filtration cartridge is mounted in the filtration assembly, the collar 420 of the filtration cartridge interacts with the seals 60, 61 and then obstructs the orifices 34, prohibiting the passage of fluid through these orifices. When the filtration cartridge is removed from the filtration assembly (integrally with the lid of the latter such as is shown in FIG. 4), the collar 420 is separated from the seals 60, 61 and the flow of fluid through the orifices 34 is then authorised.

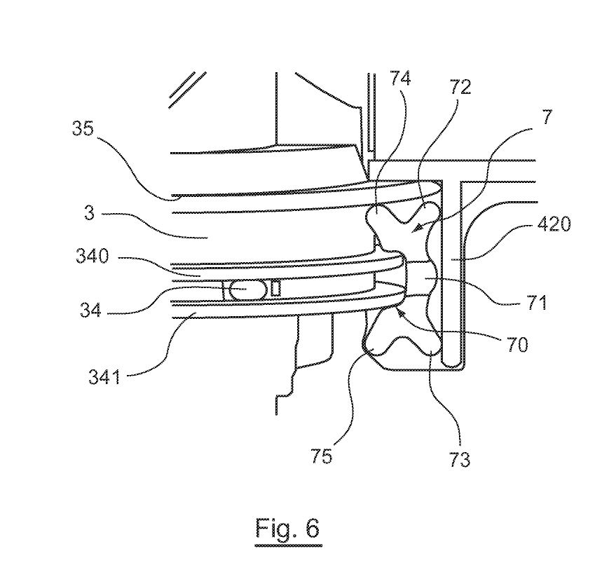

FIG. 6 shows, partially, a third embodiment of a filtration assembly.

Such as shown in this figure, a seal 7 called “four-lobe seal” is mounted on the central tube 3.

To do this, the central tube has two annular peripheral extensions 340, 341, and the seal 7 has an internal groove 70 wherein are housed the annular peripheral extensions 340, 341.

The central tube in addition has another annular extension 35, separate from the extensions 340, 341, and against which bears the upper lobes 72, 74 of the seal 7.

Note that the lower lobes 73, 75 of the seal 7 are intended to be brought for bearing, against an upper portion (not shown) of the bearing member of the central tube 3. The seal 7 is as such compressed between the extension 35 of the central tube and the bearing member of the latter, and constitutes the second sealing means in terms of this embodiment of the invention.

In addition, the external lobes 72, 73 of the seal 7 are intended to interact with the collar 420 of the filtration cartridge when the latter is mounted in the filtration assembly, this in order to provide the seal between the central tube and the filtration cartridge.

It is understood that the seal 7 as such includes the functions of the first sealing means and of the second sealing means in terms of this embodiment of the invention.

Moreover, this embodiment is further characterised by:

the fact that the central tube has one or several orifices 34 arranged between the annular peripheral extensions 340, 341, of such orifices 34 communicating with the internal recess of the central tube in order to form together a passage for drainage;

the fact that the seal 7 has one or several orifices 71 between the lobes 72, 73, and communicating with the space between the annular peripheral extensions 340, 341.

As such, when the filtration cartridge is mounted in the filtration assembly, the collar 420 of the latter interacts with the seal 7 in such a way as to obstruct the orifice 71 of the latter, prohibiting consequently the flow of fluid through orifices 71 and 34.

However, when the filtration cartridge is removed from the filtration assembly, the passage through orifices 71 and 34 is released, and the flow of fluid through the latter can take place in order to drain the tank of the filtration assembly.

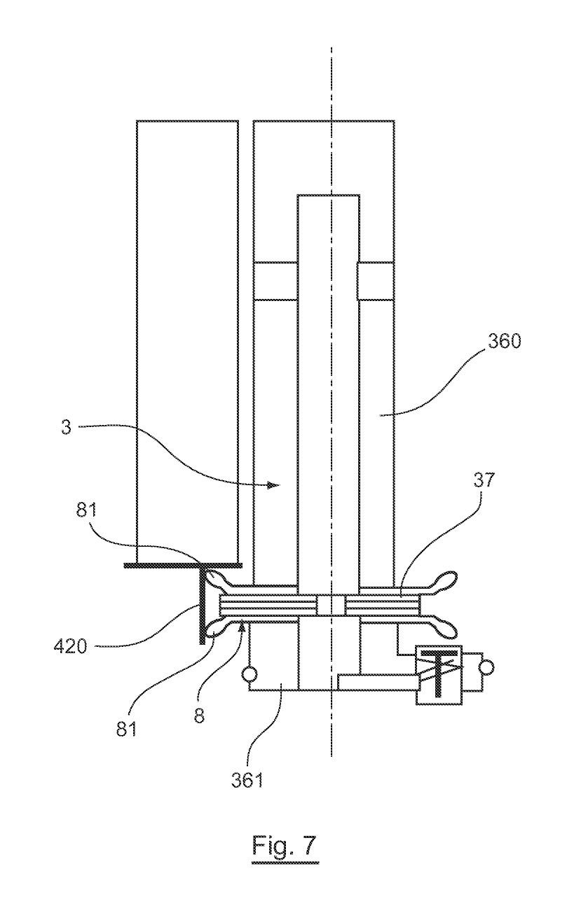

FIGS. 7 to 10 show diagrammatically a fourth embodiment of a filtration assembly according to an embodiment of the invention.

According to this embodiment, the central tube 3 comprises:

an upper portion 360, intended to interact with the filtration medium of the cartridge;

a disc 37, intended to carry a seal 8 described in more detail in what follows;

a lower portion 361 intended to be mounted on the corresponding bearing member of the tank of the filtration assembly.

The upper portion 360, the disc 37 and the lower portion 361 are integral together, via clipping.

The seal 8 comprises a central portion 80 compressed on the one hand between the upper portion 360 of the tube and the disc 37, and on the other hand between the disc 37 and the lower portion 361 of the tube.

The seal further has lobes 81 intended to interact with the collar 420 of the filtration cartridge in such a way as to provide the seal between the tube and the cartridge, the seal 8 as such constituting the first sealing means in terms of this embodiment of the invention.

Furthermore, recesses 370 are arranged in the thickness of the disc 37, these recesses 370 emerging in the central recess 371 of the disc.

As such, when the filtration cartridge is mounted inside the filtration assembly (FIG. 7), the collar 420 of the filtration cartridge obstructs the passages 370 and 371, prohibiting the flow of fluids through the latter.

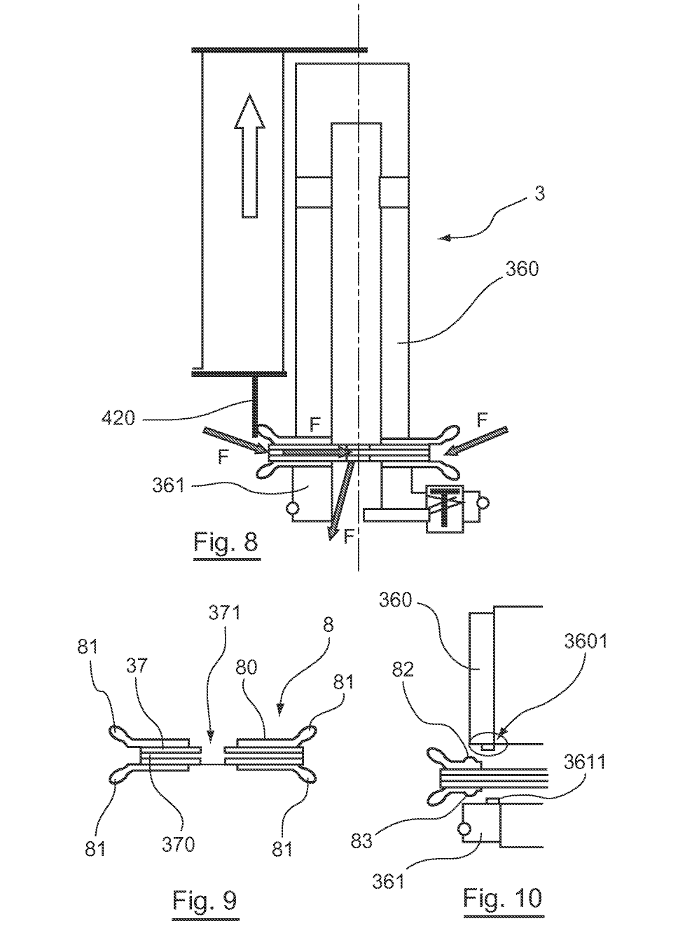

However, in the position of removal of the cartridge (FIG. 8), the passages 370, 371 are released, and the flow of fluids through the latter can take place such as is shown by the arrows F.

According to an alternative of this embodiment shown in FIG. 10, the upper portion 360 of the central tube has at its base an annular stop 3601, and the lower portion 361 of the tube has an annular stop 3611 (such stops able similarly to be arranged on the disc 37).

The seal 8 has a protuberance 82 intended to interact with the annular stop 3601 of the upper portion of the tube, and a protuberance 83 intended to interact with the annular stop 3611 of the lower portion of the tube, this in order to provide a radial maintaining of the seal on the tubes while facilitating the mounting of the latter on the disc.

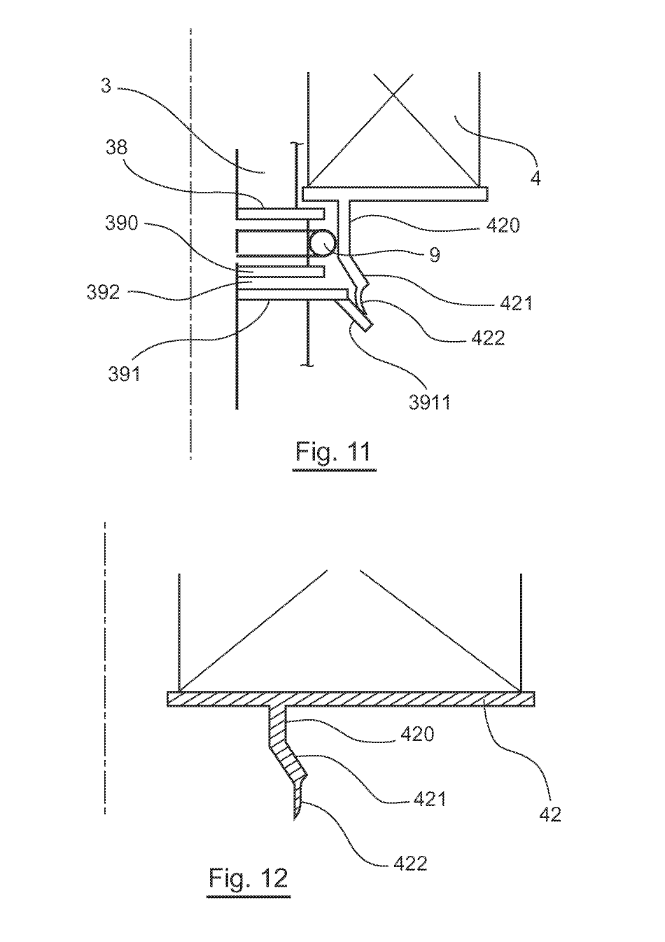

FIGS. 11 and 12 show a fifth embodiment of a filtration assembly.

According to this embodiment, the central tube 3 has two annular extensions 38, 390, delimiting a groove wherein is mounted a seal 9, preferentially of circular section.

This seal 9 is intended to interact with the collar 420 of the filtration cartridge when the latter is mounted in the filtration assembly, in such a way as to provide the seal between the tube and the filtration cartridge. The seal 9 therefore constitutes the first sealing means in terms of this embodiment of the invention.

In addition, the central tube has another annular extension 391, extending below the groove receiving the seal 9. One or several passages 392 are arranged between the annular extension 391 and the annular extension 390, this or these passages 392 communicating with the central recess of the central tube.

In parallel, the collar 420 has an extension 421 intended to interact with the annular extension 391 so as to close off the passage or passages 392 when the filtration cartridge is mounted inside the filtration assembly.

The interaction of the collar 420 with the annular extension 391 is provided by:

a terminal portion 3911 of tapered shape;

an expanded form of the extension 421 of the collar 420, carried out in such a way that the extension 421 comes to bear against the tapered terminal portion 3911 when the filtration cartridge is mounted inside the filtration assembly.

Furthermore, the end portion 422 of the extension 421 is preferentially flexible in such a way as to able to be deformed when it is brought into contact with the tapered terminal portion 3911.

Furthermore, the stiffness of the end portion 422 is sufficient in order to provide a seal with regards to the passage of fluids between the extension 421 and the annular extension 391.

According to this embodiment, the flow of fluid in the passage for drainage (here constituted in part of the central recess of the central tube) is obstructed by the end portion 422 interacting with the tapered terminal portion 3911 of the annular extension of the tube, when the cartridge is mounted inside the filtration assembly.

However, in the removal position of the cartridge, the passage or passages 392 are released, and the flow of fluid can take place through the latter, in the direction of the passage for drainage.

An embodiment of the invention provides a filtration assembly which limits the quantity of parts and/or materials to be removed after renewal of the cartridge.

An embodiment of the invention limits the cost of the cartridge.

An embodiment of the invention provides such a filtration assembly which favours the return of the liquid, during the changing of the cartridge, towards the reservoir of liquid, without for this requiring a specific intervention of the operator performing the renewal.

An embodiment of the invention provides such a filtration assembly which is simple in design and easy to implement.

Although the present disclosure has been described with reference to one or more examples, workers skilled in the art will recognize that changes may be made in form and detail without departing from the scope of the disclosure and/or the appended claims.

1. A filtration assembly for a fluid flowing in an engine, comprising:
a tank;
a bearing member integral with said tank;
a central tube mounted on the tank and intended to interact with a filtration cartridge comprising an upper flange and a lower flange between which extends a filtration medium and further comprising a collar forming an extension on said lower flange, said central tube being permanently mounted on said bearing member;
first sealing means carried by said central tube for providing a seal between said tube and said cartridge; and
second sealing means for interacting with at least one of said bearing member or said collar in such a way as to provide a seal between said tank and said tube.

2. The filtration assembly according to claim 1, wherein the filtration assembly comprises a passage for drainage of said fluid to allow a flow of said fluid from said tank, and means for closing off of said passage for drainage, prohibiting said flow in the a position of interaction of said collar with said first or second sealing means, and allowing said flow in a position of removal of said cartridge from said set.

3. The filtration assembly according to, claim 1, wherein said first sealing means are constituted of a central portion of a seal intended to be compressed between said central tube and said bearing member, said second sealing means being constituted of at least one external radial extension of said seal extending from said central portion and intended to be compressed by said collar in the direction of said central portion.

4. The filtration assembly according to claim 3, wherein said radial extension or radial extensions are constituted of a lip extending from said central portion in a manner inclined downwards.

5. The filtration assembly according to claim 2, wherein said passage for drainage is arranged in said tank externally to said bearing member, said means for closing off comprising a flap which can be actuated by said lower flange.

6. The filtration assembly according to claim 5, wherein said flap is integral with a plunger intended to interact with said lower flange in order to bring said flap in a position prohibiting said flow, said plunger being coupled to means for elastically recalling said flap in a position allowing said flow.

7. The filtration assembly according to, claim 1, wherein said first sealing means comprise two seals mounted on said central tube in a separated manner from one another with both being positioned to interact with said collar.

8. The filtration assembly according to claim 2, wherein said first sealing means comprise two seals mounted on said central tube in a separated manner from one another with both being intended to interact with said collar, and wherein said passage for drainage comprises at least one orifice arranged in said central tube between said two seals.

9. The filtration assembly according to claim-8, wherein said seals include a central portion housed in an annular groove of said central tube, and a radial extension intended to be compressed by said collar.

10. The filtration assembly according to claim 1, wherein said first and second sealing means include a seal comprising a central portion and at least two peripheral radial extensions separated from one another and intended to be compressed by said collar, said central portion being compressed between said central tube and said bearing member.

11. The filtration assembly according to claim 10, wherein said central portion of said seal comprises, between said peripheral radial extensions, at least one communication orifice with a passage for drainage of said fluid.

12. The filtration assembly according to claim 10, wherein said central tube comprises an upper portion intended to interact with said medium and a lower portion comprising a disc carrying said seal and in the thickness of which are arranged said orifice or said orifices.

13. The filtration assembly according to claim 12, wherein at least one of said upper portion or said disc has an annular stop intended to interact radially with said seal.

14. The filtration assembly according to claims 1, wherein said tube has, below said first sealing means, at least one orifice communicating with said passage for drainage, said means for closing off comprising at least one radial extension of said central tube extending below said orifice and at least one extension of said collar, said radial extension being intended to interact with said at least one extension of said collar in order to prohibit said flow.

15. The filtration assembly according to claim 14, wherein said radial extension of said central tube has a tapered terminal portion, said radial extension extending in an expanded manner in relation to said collar in such a way as to have an end portion intended to bear against said tapered terminal portion.

16. The filtration assembly according to claim 15, wherein said end portion is flexible.

17. An apparatus comprising:
a tank and a bearing member integral with said tank;
a filtration cartridge comprising an upper flange and a lower flange between which extends a filtration medium and further comprising a collar forming an extension on said lower flange; and
a central tube mounted on the tank and interacting with the filtration cartridge, said central tube being permanently mounted on said bearing member and carrying a first seal and a second seal, wherein the first seal interacts with the collar carried by said central tube in such a way as to provide a seal between said tube and said cartridge, and wherein said second seal interacts with said bearing member and/or said collar in such a way as to provide a seal between said tank and said tube.
